(19) United States
(12) Patent Application Publication
(10) Pub. No.: US 2024/0361074 A1
(43) Pub. Date: Oct. 31, 2024

(54) PARALLEL-FLOW REGENERATIVE SHAFT KILN AND METHOD FOR BURNING CARBONATE ROCK

(71) Applicants: Maerz Ofenbau AG, Zurich (CH); thyssenkrupp Polysius GmbH, Beckum (DE); thyssenkrupp AG, Essen (DE)

(72) Inventors: Hannes PIRINGER, Beinwil am See (CH); Patrick BUCHER, Schoenenwerd (CH); Roger WALLIMANN, Zurich (CH); Dirk SCHEFER, Ennigerloh (DE)

(73) Assignees: Maerz Ofenbau AG, Zurich (CH); thyssenkrupp Polysius GmbH, Beckum (DE); thyssenkrupp AG, Essen (DE)

(21) Appl. No.: 18/287,794

(22) PCT Filed: Apr. 25, 2022
(86) PCT No.: PCT/EP2022/060929

§ 371 Date: Oct. 20, 2023

(30) Foreign Application Priority Data
Apr. 27, 2021 (BE) BE 2021/5326
Apr. 27, 2021 (DE) 10 2021 204 176.0

(51) Int. Cl. F27B 1/00; C04B 7/44; C04B 7/47; F27B 1/02; F27B 1/16; F27B 1/22; F27D 9/00; F27D 17/00; F27D 19/00

(52) U.S. Cl. CPC F27B 1/005; C04B 7/4469; C04B 7/475; F27B 1/02; F27B 1/16; F27B 1/22; F27D 9/00; F27D 17/004; F27D 2009/0075; F27D 2017/007; F27D 2019/0015; F27M 2003/03

(57) ABSTRACT

A method for burning material, such as carbonate rocks, in a parallel-flow regenerative shaft kiln having two shafts which are operated alternately as a burning shaft and as a regenerative shaft and are connected to one another by means of a connecting channel, wherein the material flows through a material inlet into a preheating zone for preheating the material, a burning zone for burning the material and a cooling zone for cooling the material to a material outlet, wherein a cooling gas is admitted into the cooling zone, wherein exhaust gas is discharged from one of the shafts via an exhaust gas outlet, wherein the exhaust gas discharged from the shaft via the exhaust gas outlet is at least partially introduced into at least one of the shafts.

The invention relates to a parallel-flow regenerative shaft kiln (PFR shaft kiln), and to a method for burning and cooling material, such as carbonate rocks, with a PFR shaft kiln.

Burning of carbonate rock in a PFR shaft kiln has been known for about 60 years. A PFR shaft kiln of this kind which is known for example from WO 2011/072894 A1 has two vertical, parallel shafts which operate in cycles, wherein burning is performed only in one shaft, the respective burning shaft, while the other shaft operates as a regenerative shaft. The burning shaft is supplied with oxidation gas in parallel flow with the material and fuel, wherein the resultant hot exhaust gases, together with the heated cooling air which is supplied from below, are conducted via the flow transfer channel into the exhaust gas shaft, where the exhaust gases are conducted away toward the top in counter flow to the material and the material is preheated in the process. The material is usually fed into the shaft from above together with the oxidation gas, wherein fuels are injected in the burning zone.

In each shaft, the material to be burned usually passes through a preheating zone for preheating the material, a burning zone which is subsequent thereto and in which the material is burned, and a cooling zone which is subsequent thereto and in which cooling air is supplied to the hot material.

In order to meet the quality requirements with respect to high reactivity of the burnt lime, as required for example in steelworks, the temperatures in the burning zone must not exceed a value of 1100° C., preferably 1000° C. Furthermore, the demand for environmentally friendly production of burnt lime is also increasing, and so certain requirements for the CO2 content of the exhaust gas for subsequent aftertreatment must be met.

Proceeding therefrom, the object of the present invention is to provide a PFR shaft kiln and a method for burning carbonate rock with a PFR shaft kiln, with which lime with a high reactivity is made possible while CO2 is simultaneously separated from the exhaust gas.

This object is achieved according to the invention by an apparatus having the features of independent method claim 1 and by a method having the features of independent apparatus claim 10. Advantageous developments will become apparent from the dependent claims.

According to a first aspect, the invention encompasses a method for burning and cooling material, such as carbonate rocks, in a parallel-flow regenerative shaft kiln having two shafts which are operated alternately as a burning shaft and as a regenerative shaft and are connected to one another by means of a connecting channel. In the PFR shaft kiln, the material flows through a material inlet into a preheating zone for preheating the material, a burning zone for burning the material and a cooling zone for cooling the material to a material outlet, wherein a cooling gas is admitted into the cooling zone. A co-current burning zone is formed in the shaft operated as a burning shaft. The exhaust gas is discharged from one of the shafts via an exhaust gas outlet arranged inside or above the preheating zone, wherein the exhaust gas discharged from the shaft via the exhaust gas outlet is at least partially introduced into at least one of the shafts. For example, the exhaust gas is introduced directly into one of the shafts or indirectly via the connecting channel.

The material to be burned is preferably limestone or dolomite rock having a grain size of 10 to 200 mm, preferably of 15 to 120 mm, most preferably 30 to 100 mm. The cooling gas is air, for example.

The parallel-flow regenerative shaft kiln has at least two shafts which are preferably arranged parallel to one another and vertically. The shafts can be operated alternately as a burning shaft and as a regenerative shaft, wherein each shaft has, in the direction of flow of the material, a preheating zone for preheating the material, a burning zone for burning the material and a cooling zone for cooling the material. Each shaft preferably has a material inlet for admitting material to be burned into the shaft, wherein the material inlet is located in particular at the upper end of the respective shaft so that the material falls into the respective shaft due to gravity. The material inlet and/or the material outlet is/are in particular in the form of a lock for admitting and/or discharging material into the shaft kiln. A material inlet in the form of a lock is preferably designed such that only the raw material to be burned passes into the shaft, but not the ambient air. The material lock also prevents gas escaping from the shaft via the material inlet. The lock is preferably configured such that it seals off the shaft against the environment in an airtight manner and allows solids, such as the material to be burned, to enter the shaft.

The connecting channel is configured to connect the two shafts in terms of gas and preferably connects the burning zones of the shafts to one another. During operation of the PFR shaft kiln, in each case one of the shafts is operated as a burning shaft and is active, with the respective other shaft being operated as a regenerative shaft and being passive. The PFR shaft kiln is in particular operated in cycles, with the function of the shafts being swapped after the cycle time has expired. This procedure is repeated continuously. In the active shaft operated as a burning shaft, a fuel is introduced into the burning zone via the burner lances. The material to be burned is heated in the preheating zone of the burning shaft preferably to a temperature of about 700° C. In the shaft operated as a burning shaft, the burning zone is in the form of a co-current burning zone, wherein the material to be burned flows parallel to the gas. The gas flows inside the burning shaft from the preheating zone into the burning zone and then via the connecting channel into the burning zone and the preheating zone of the regenerative shaft. In the shaft operated as a regenerative shaft, the gas flows in the preheating zone and the burning zone in countercurrent to the material to be burned.

Both in the burning shaft and in the regenerative shaft, cooling gas is conducted through the cooling zone in countercurrent to the material to be cooled and is preferably completely discharged from the shaft via the cooling gas outlet of the cooling air extraction device so that preferably no cooling gas flows from the cooling zone into the burning zone.

Each shaft preferably has at least one exhaust gas outlet, for example at the upper end of the shaft inside the preheating zone. The exhaust gas outlet is preferably arranged above the material column in a material-free region of the preheating zone. The exhaust gas is preferably discharged exclusively from one shaft, in particular the regenerative shaft. The discharged exhaust gas is preferably fed to the respective other shaft, in particular the burning shaft, and/or via the connecting channel to the regenerative shaft. Preferably, only part of the exhaust gas discharged from the regenerative shaft is fed back to at least one shaft. Part of the exhaust gas discharged from the regenerative shaft is for example discharged from the PFR shaft kiln and for example fed to a further treatment, such as a sequestration. The exhaust gas preferably consists of CO₂ and optionally H₂O.

Returning the exhaust gas into at least one shaft makes it possible to produce lime with a high reactivity, with process gas having a CO2 content of more than 90% based on dry gas being produced at the same time. With such a process exhaust gas, it is possible to liquefy and sequester it with less effort. For example, the liquefied process exhaust gas is fed to further process steps or stored. Alternatively, exhaust gas having a lower CO2 content, for example 45% for soda production or 35% for sugar production or 30% for the production of precipitated calcium carbonate, can be also generated with the previously described PFR shaft kiln. According to a first embodiment, the exhaust gas is introduced into the preheating zone of the shaft operated as a burning shaft. Each shaft preferably has a gas inlet, in particular a combustion gas inlet, which is arranged in the upper region of the shaft in the preheating zone and serves for the admission of the gas required for combustion. The gas inlet is preferably arranged above the material column in a material-free space of the preheating zone. A control element, such as a flap or an adjustable-volume compressor, is preferably connected upstream of the combustion gas inlet and can be used to adjust the amount of exhaust gas and/or oxidizing agent in the shaft. The exhaust gas discharged from the shaft via the exhaust gas outlet preferably has a temperature of about 60° C.-160° C., in particular 100° C. Preferably, only part of the exhaust gas is introduced into the preheating zone of the burning shaft. Returning the exhaust gases into the preheating zone offers the possibility of increasing the amount of gas in the shaft, with a high CO2 concentration in the exhaust gas simultaneously being ensured.

According to a further embodiment, the exhaust gas is introduced into the connecting channel and/or into the burning zone of the shaft operated as a regenerative shaft or burning shaft. The connecting channel is preferably in the form of a material-free space in which gas from the burning shaft flows to the regenerative shaft. Introducing the exhaust gas into the connecting channel makes it possible to uniformly mix the exhaust gas with the gases in the burning zone of the burning shaft, since there is no material in the connecting channel. Preferably, only part of the exhaust gas is introduced into the connecting channel and/or into the burning zone of the regenerative shaft.

According to a further embodiment, before being introduced into the shaft, in particular into the connecting channel or into the burning zone of the shaft operated as a regenerative shaft or burning shaft, the exhaust gas is heated in particular to a temperature of 900° C. to 1100° C., preferably 1000° C. The exhaust gas is preferably heated in two steps, with heating to about 600° C. being performed in a first step and heating to about 1000° C. being performed in a further step. The steps are performed for example in separate devices, such as an electric heater or heat exchanger.

The heat exchanger is for example a heat exchanger in the form of a regenerator or a heat exchanger in the form of a recuperator. The recuperator is for example a countercurrent recuperator, wherein the exhaust gas is heated in countercurrent to a fluid, such as the cooling gas extracted via the cooling gas extraction device. The recuperator is for example a plate heat exchanger or a shell-and-tube heat exchanger. A heat exchanger in the form of a regenerator is preferably operated in cycles. For example, the heat exchanger comprises two regenerators which are connected in parallel to one another and are each connected to the exhaust gas line and the cooling gas extraction line via a respective valve. The extracted cooling gas flows in each case through exactly one of the regenerators in order to heat the regenerator. The exhaust gas to be heated flows through the respective other regenerator. After a certain time, in particular when switching the shafts between the burning and regeneration operations, the operating modes of the regenerators are switched, so that the extracted cooling gas flows through the respective other regenerator with the exhaust gas to be heated. The advantage of a regenerator in comparison with a recuperator, which is designed for example as a shell-and-tube heat exchanger, is that the regenerator stores the heat in ceramic materials and therefore does not corrode or scale at high temperatures.

According to a further embodiment, the exhaust gas is heated by means of a heat exchanger and/or a heating device, in particular an electrical heating device, a solar device or a combustion reactor. For example, the exhaust gas is heated exclusively by a heat exchanger or a heating device. It is also conceivable to heat the exhaust gas in a first step by a heat exchanger to a temperature of for example about 600° C. and then in a heating device to a temperature of about 1000° C.

The heating device is preferably configured for indirect heating or for direct heating, for example by means of an oxyfuel burner. The heating device comprises for example an electrical heating device, an electrical flow heater, a solar device, a combustion reactor and/or a heat exchanger and can be operated in particular with renewable energy sources. The heating device is for example an electrically operated heating device. In particular, the heating device is operated by means of solar energy and preferably comprises a solar receiver, in particular a photovoltaic system for generating electrical energy by means of solar energy. The heating device comprises for example a solar thermal system, wherein for example a heat exchanger fluid is heated by means of solar energy and in a heat exchanger heats the recirculated exhaust gas, preferably in countercurrent to said exhaust gas. For example, the heating device comprises a solar receiver that heats the recirculated exhaust gas in particular directly. To this end, the solar receiver comprises for example part of the exhaust gas outlet line. For example, the heating device has a combustion reactor which is preferably configured for the combustion of renewable energy sources, such as wood, wherein oxygen is preferably supplied instead of air in order to avoid the entry of nitrogen. The heating device preferably comprises a heat exchanger for heating the exhaust gas in countercurrent to a heat transfer fluid. The heat transfer fluid is heated for example by means of solar energy and/or the combustion reactor.

According to a further embodiment, the cooling gas heated in the cooling zone is discharged from the cooling zone of the shaft via a cooling gas extraction device. In particular, the cooling gas admitted into the cooling zone is completely discharged from the respective shaft via the cooling gas extraction device. The cooling gas is preferably admitted into the cooling zone from below via a cooling gas inlet arranged in the lower region of the cooling zone. The cooling gas extraction device preferably has a cooling gas outlet for discharging the cooling gas from the shaft. The cooling gas outlet is in particular connected to a cooling gas extraction line for conducting the extracted cooling gas.

According to a further embodiment, the cooling gas discharged from the cooling zone is fed to a heat exchanger for heating the exhaust gas. Before being introduced into the connecting channel and/or the burning zone of the regenerative shaft, the exhaust gas extracted via the exhaust gas outlet is preferably heated in countercurrent by the extracted cooling gas. The exhaust gas is preferably heated to a temperature of 400° C. to 800° C., in particular 600° C., by means of the heat exchanger.

According to a further embodiment, an oxidizing agent is fed to the shaft operated as a burning shaft. The oxidizing agent is for example pure oxygen or oxygen-rich gas having a proportion of oxygen of at least 70% to 95%, preferably 90%. The oxidizing agent is preferably introduced into the preheating zone of the burning shaft together with the exhaust gas. It is also conceivable for the shaft to have, in the preheating zone, a separate oxidizing agent inlet for the admission of the oxidizing agent into the shaft separately from the exhaust gas.

According to a further embodiment, the content of oxygen and/or CO₂ in the exhaust gas and/or the cooling gas is determined, wherein the amount of oxidizing agent fed to the burning shaft and/or the amount of cooling gas discharged from the cooling zone of the shaft via the cooling gas extraction device is controlled.

The PFR shaft kiln preferably has a gas analysis device for determining the oxygen and/or CO2 content in the exhaust gas and/or cooling gas. The gas analysis device is arranged for example in the exhaust gas line, in particular downstream of the branching-off point of the combustion gas line. Optionally or additionally, a gas analysis device is arranged in the cooling gas extraction line, in particular downstream of the heat exchanger and for example of the filter.

In particular, the gas analysis device is connected to a control device for transmitting the determined oxygen and/or CO₂ content of the exhaust gas and/or of the cooling gas.

The oxidizing agent line preferably has a control element, such as a valve or a flap, which can be used to adjust the amount of oxidizing agent in the respective shaft. The control element is preferably connected to the control device, with the control device being configured in particular such that it controls the amount of oxidizing agent in the shaft depending on the oxygen and/or CO₂ content of the exhaust gas that is determined by means of the gas analysis device. The control device is preferably configured such that it compares the oxygen and/or CO₂ content determined by means of the gas analysis device with a respective predetermined limit value or limit range and, in the case of a deviation of the determined value from the limit value or limit range, increases or reduces the amount of oxidizing agent in the shaft.

The control serves in particular for complete combustion of the fuel that is fed to the PFR shaft kiln via the fuel line. An undesirably high proportion of oxygen in the exhaust gas line is thus prevented. The CO₂ content is also measured in order to control the desired CO₂ content in the exhaust gas line.

The cooling gas extraction line preferably has a control element, such as a valve or a flap, which can be used to adjust the amount of cooling gas to be discharged via the cooling gas extraction device. The control element is preferably connected to the control device, with the control device being configured in particular such that it controls the amount of cooling gas discharged via the cooling gas extraction device depending on the oxygen and/or CO₂ content of the cooling gas that is determined by means of the gas analysis device. The control device is preferably configured such that it compares the oxygen and/or CO₂ content determined by means of the gas analysis device with a respective predetermined limit value or limit range and, in the case of a deviation of the determined value from the limit value or limit range, increases or reduces the amount of cooling gas to be discharged via the cooling gas extraction device.

The control serves in particular to remove the cooling gas from the PFR shaft kiln as completely as possible while at the same time having as little CO₂ as possible or preferably no CO₂ in the cooling gas extraction line.

According to a further embodiment, the shafts each have at least one burner lance, wherein the exhaust gas is introduced into the burner lance. A fuel is preferably fed to the burning zone and/or the preheating zone of the shaft operated as a burning shaft via a fuel line. The fuel is preferably fed to burner lances arranged in the burning zone and/or the preheating zone. The fuel is for example a fuel gas, such as blast furnace gas or natural gas, or coal dust or biomass or liquid fuels. The material is preferably heated to a temperature of about 1100° C. in the burning zone. In particular, the exhaust gas is introduced into the fuel line. To this end, the exhaust gas line is preferably connected to the fuel line and/or the at least one burner lance. Preferably, downstream of the heat exchanger the exhaust gas is introduced into the burner lance and/or the fuel line, the heat exchanger preferably being the heat exchanger for heating the exhaust gas in countercurrent to the extracted cooling gas. The exhaust gas is preferably not heated any further between this heat exchanger and the introduction into the burner lance and/or fuel line; in particular, a previously described heating device is not provided. The exhaust gas is preferably introduced into the burner lance and/or the fuel line via a control element, such as a flap or a valve, in order to adjust the amount of exhaust gas in said burner lance and/or fuel line. Each fuel line and/or burner lance is preferably assigned a control element for adjusting the amount of exhaust gas in the respective burner lance and/or fuel line. The control element is preferably arranged in the exhaust gas line. In particular, the exhaust gas is introduced into the burner lances of the shaft operated as a burning shaft. Introducing the exhaust gas into the burner lances and/or the fuel line makes it possible to dispense with the heating device, since the exhaust gas is heated directly together with the fuel. This embodiment therefore represents a cost-effective solution.

Each shaft preferably has a multiplicity of burner lances which extend at least partially through the preheating zone and in particular open into the burning zone of the respective shaft and serve to conduct for example fuel and/or an oxidizing gas, such as air or air enriched with oxygen or pure oxygen.

The invention also encompasses a parallel-flow regenerative shaft kiln for burning and cooling material, such as carbonate rocks. The embodiments and advantages described with reference to the method for burning material, such as carbonate rocks, in a parallel-flow regenerative shaft kiln also apply to the PFR shaft kiln in a corresponding manner in terms of apparatus.

The PFR shaft kiln comprises having two shafts which are operated alternately as a burning shaft and as a regenerative shaft and are connected to one another by means of a connecting channel. Each shaft has, in the direction of flow of the material, a preheating zone for preheating the material, a burning zone for burning the material and a cooling zone for cooling the material.

Each shaft also has an exhaust gas outlet arranged inside or above the preheating zone for discharging exhaust gas from the shaft. The at least one exhaust gas outlet is connected to a gas inlet for admitting gas into at least one shaft. Preferably, the PFR shaft kiln has a multiplicity of gas inlets for admitting exhaust gas extracted from at least one of the shafts. The PFR shaft kiln is configured and set up in such a way that a co-current burning zone is formed in the shaft operated as a burning shaft.

According to one embodiment, the gas inlet is arranged in the preheating zone of the shaft operated as a burning shaft. The gas inlet in the preheating zone of the burning shaft is preferably a combustion gas inlet, via which an oxidizing agent is preferably introduced into the preheating zone in addition to the exhaust gas. The gas inlet is preferably arranged at the upper end of the preheating zone.

According to a further embodiment, the gas inlet is arranged in the connecting channel for connecting the burning zones of the shafts in terms of gas and/or arranged in the burning zone of the shaft, in particular of the regenerative shaft or of the burning shaft, and/or in a material-free space in the shaft. In particular, the material-free space is in the form of an external annular space which extends circumferentially around preferably the upper region of the cooling zone adjacent to the burning zone.

According to a further embodiment, arranged between the exhaust gas outlet and the gas inlet in the connecting channel for connecting the burning zones of the shafts in terms of gas and/or in the burning zone is a heat exchanger and/or a heating device, in particular an electrical heating device, a solar device or a combustion reactor, for heating the exhaust gas. For example, the heat exchanger is arranged upstream of the heating device in the direction of flow of the exhaust gas. It is also conceivable that there is only a heat exchanger or a heating device for heating the exhaust gas.

According to a further embodiment, the cooling zone has a cooling gas inlet for admitting cooling gas into the cooling zone and a cooling gas extraction device for discharging cooling gas from the shaft.

The cooling gas extraction device has, according to a further embodiment, a material-free space inside the cooling zone of the shaft. In particular, the material-free space is in the form of an external annular space which extends circumferentially around preferably the upper region of the cooling zone adjacent to the burning zone. In particular, the cooling gas outlet is arranged in the material-free annular space.

The material-free space of the cooling gas extraction device is in the form for example of an inner cylinder which extends in particular centrally and in the vertical direction through the cooling zone. In particular, the inner cylinder extends at least partially into the burning zone. The cooling gas outlet for discharging the cooling gas from the shaft is arranged in the inner cylinder. The inner cylinder preferably has a cooling gas inlet for admitting cooling gas of the cooling zones into the interior of the inner cylinder, where the cooling gas inlet is preferably arranged above the cooling gas outlet in the inner cylinder. In particular, the cooling gas inlet is arranged at the upper end of the cooling zone, so that the cooling gas preferably flows through the entire cooling gas zone and then into the inner cylinder of the cooling gas extraction device. Inside the inner cylinder, the cooling gas preferably flows downward in the direction of the cooling gas outlet and into the cooling gas extraction line. A cooling gas extraction device in the form of an inner cylinder enables a low structural height of the cooling zone and comparatively easy retrofitting of known PFR shaft kilns.

The material-free space of the cooling gas extraction device is in the form for example of a connecting channel for connecting the cooling zones of the two shafts in terms of gas, where the cooling gas outlet is preferably arranged in the connecting channel, in particular centrally.

The cooling gas extraction device is preferably configured such that it discharges all of the cooling gas from the shaft so that preferably no cooling gas passes into the burning zone or the connecting channel for connecting the burning zones of the shafts. In particular, the cooling gas extraction device is connected to a control element, such as a flap or a valve, in order to adjust the amount of cooling gas to be extracted.

According to a further embodiment, the cooling gas extraction device is connected to a heat exchanger for heating the exhaust gas. The cooling gas extraction device is connected to the heat exchanger in particular by means of the cooling gas extraction line.

The heat exchanger preferably serves to heat the exhaust gas that was discharged from the preheating zone of the regenerative shaft via the exhaust gas outlet. The heat exchanger is in particular connected to the exhaust gas outlet and the cooling gas outlet of the cooling gas extraction device.

According to a further embodiment, each shaft has a combustion gas inlet for admitting combustion gas into the preheating zone and/or the burning zone, wherein the combustion gas inlet is connected to an oxidizing agent line for conducting an oxidizing agent into the shaft. The combustion gas inlet is preferably connected to the exhaust gas outlet for conducting the exhaust gas into the shaft.

### DESCRIPTION OF THE DRAWINGS

The invention is described in more detail below on the basis of multiple exemplary embodiments with reference to the appended figures.

FIG. 1 shows a schematic illustration of a PFR shaft kiln in a sectional view according to one exemplary embodiment.

FIG. 2a shows a schematic illustration of a PFR shaft kiln in a sectional view according to a further exemplary embodiment.

FIGS. 2b to 2f show schematic illustrations of the PFR shaft kiln of FIG. 2a in cross-sectional views in the sectional planes marked in FIG. 2a.

FIG. 3a shows a schematic illustration of a PFR shaft kiln in a sectional view according to a further exemplary embodiment.

FIGS. 3b to 3e show schematic illustrations of the PFR shaft kiln of FIG. 3a in a longitudinal view and further cross-sectional views in the sectional planes marked in FIG. 3a.

FIGS. 4a-c show a schematic illustration of a PFR shaft kiln in a perspective view and two sectional views according to a further exemplary embodiment.

FIGS. 4d to 4h show schematic illustrations of the PFR shaft kiln of FIGS. 4a-c in a longitudinal view and further cross-sectional views in the sectional planes marked in FIGS. 4b and c.

FIG. 5 shows a schematic illustration of a PFR shaft kiln in a sectional view according to a further exemplary embodiment.

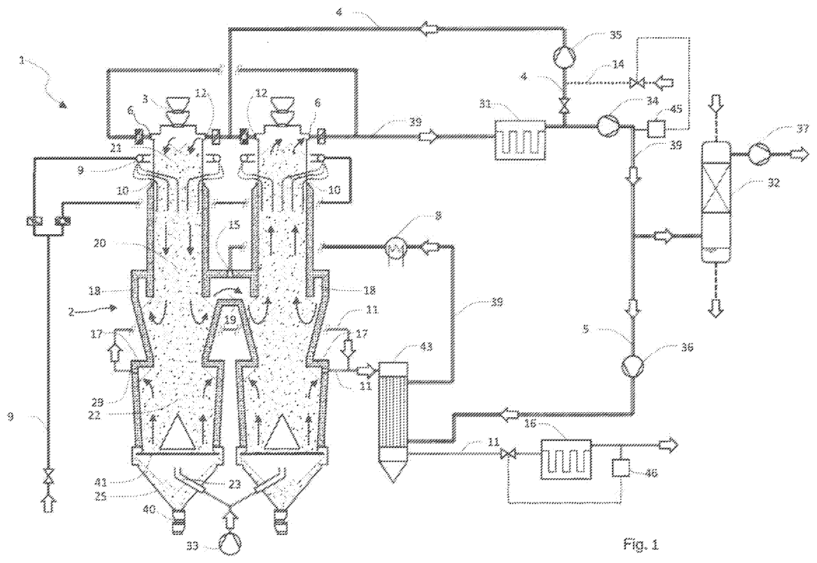

FIG. 1 shows a PFR shaft kiln 1 having two parallel and vertically oriented shafts 2. The shafts 2 of the PFR shaft kiln 1 are of substantially identical construction, and so only one of the two shafts 2 is provided with reference signs in FIG. 1 and only one of the two shafts 2 is described below for the sake of simplicity. Each shaft 2 has a respective material inlet 3 for admitting material to be burned into the respective shaft 2 of the PFR shaft kiln 1. The material to be burned is in particular limestone and/or dolomite rock preferably having a grain size of 10 to 200 mm, preferably of 15 to 120 mm, most preferably 30 to 100 mm. By way of example, the material inlets 3 are arranged at the upper end of the respective shaft 2 so that the material falls through the material inlet 3 into the shaft 2 due to gravity. The material inlet 3 is for example in the form of an upper opening in the shaft 2 and in particular in the form of a lock 3 and preferably extends over the entirety or a portion of the cross section of the shaft 2. A material inlet in the form of a lock 3 is preferably designed such that only the raw material to be burned passes into the shaft 2, but not the ambient air. The lock 3 is preferably configured such that it seals off the shaft 2 against the environment in an airtight manner and allows solids, such as the material to be burned, to enter the shaft.

Each shaft 2 also has, at its upper end, a combustion gas inlet 12 for admitting combustion gas for the combustion of fuels. The combustion gas is for example dedusted exhaust gas from at least one of the shafts 2, with the exhaust gas preferably being enriched with oxygen. Furthermore, each shaft 2 has an exhaust gas outlet 6 for discharging exhaust gases from the respective shaft 2. By way of example, a respective control element is assigned to each exhaust gas outlet 6 and combustion gas inlet 12. The control elements, such as an adjustable-volume compressor 35, can preferably be used to adjust the amount of combustion gas in the respective combustion gas inlet 12 and the amount of exhaust gas to be extracted via the respective exhaust gas outlet 6. The combustion gas inlet 12 and the exhaust gas outlet are arranged by way of example at the same height level and in particular inside the preheating zone 21 of the respective shaft 2.

Arranged at the lower end of the shaft 2 is a material outlet 40 for discharging the burned material. The material outlet 40 is for example a lock as described with reference to the material inlet 3.

The burned material is conducted for example into an outlet funnel 25, which is adjoined by the material outlet 40 of the shaft 2. By way of example, the outlet funnel 25 is funnel-shaped. The outlet funnel 25 preferably has a cooling gas inlet 23 for admitting cooling gas into the respective shaft 2. The cooling gas is preferably conducted into the cooling gas inlet by means of a compressor 33.

During operation of the PFR shaft kiln 1, the material to be burned flows from the top to the bottom through the respective shaft 2, wherein the cooling air flows from the bottom to the top, in countercurrent to the material, through the respective shaft 2. The furnace exhaust gas is discharged from the shaft 2 through the exhaust gas outlet 6.

The preheating zone 21 of the respective shaft 2 adjoins in the direction of flow of the material below the material inlet 3 and the combustion gas inlet 12. The material and the combustion gas are preferably preheated to about 700° C. in the preheating zone 21. The respective shaft 2 is preferably filled with material to be burned. The material is preferably fed into the respective shaft 2 above the preheating zone 21. At least part of the preheating zone 21 and that part of the respective shaft 2 which adjoins it in the direction of flow of the material are surrounded with a refractory lining, for example.

A multiplicity of burner lances 10 are optionally arranged in the preheating zone 21 and each serve as an inlet for fuel, such as fuel gas, oil or ground solid fuel. The PFR shaft kiln 1 has for example a cooling device for cooling the burner lances 10. The cooling device comprises for example a multiplicity of cooling air ring lines which extend annularly around the shaft region in which the burner lances 10 are arranged. Cooling air for cooling the burner lances 10 preferably flows through the cooling air ring lines. Preferably, the burner lances 10 are cooled by means of the exhaust gas discharged via the exhaust gas outlet 6. The exhaust gas outlet 6 is preferably connected to the burner lances 10 for conducting exhaust gas to the burner lances 10.

A multiplicity, for example twelve or more, of burner lances 10 are preferably arranged in each shaft 2 at a substantially uniform distance from one another. By way of example, the burner lances 10 have an L shape and preferably extend in a horizontal direction into the respective shaft 2 and in a vertical direction, in particular in the direction of flow of the material, inside the shaft 2. The ends of the burner lances 10 of a shaft 2 are preferably all arranged at the same height level. Preferably, the plane on which the lance ends are arranged is in each case the lower end of the respective preheating zone 21. The burner lances 10 are preferably connected to a fuel line 9 for conducting fuel to the burner lances 10. By way of example, the fuel line 9 is at least partially in the form of a ring line which extends circumferentially around the respective shaft 2. Preferably, each shaft 2 has a fuel line which is assigned in each case to the burner lances 10 of the shaft 2 and which in particular has a respective control element for adjusting the amount of fuel to the burner lances 10.

The burning zone 20 adjoins the preheating zone 21 in the direction of flow of the material. In the burning zone 20, the fuel is combusted and the preheated material is burned at a temperature of about 1000° C. The PFR shaft kiln 1 furthermore has a connecting channel 19 for connecting the two shafts 2 to one another in terms of gas. There is in particular no material to be burned in the connecting channel 19.

By way of example, FIG. 1 shows a PFR lime kiln 1 with round shaft cross sections. However, the shaft cross section can have a different geometric contour, such as round, semicircular, oval, square or polygonal. The burner zone 20 extends by way of example in a first and a second shaft section, where the first shaft section has a cross section that is substantially constant or becomes slightly larger toward the bottom. The first shaft section is adjoined in the direction of flow of the material by a second shaft section which has a shaft cross section that decreases in the direction of flow of the material. The lower region of the first shaft section extends into the upper region of the second shaft section, with the result that an annular channel 18 is formed between the two shaft sections. The annular channel 18 forms a material-free space in which no material to be burned is arranged. The upper region of the second shaft section has a larger cross section than the first shaft section, with the cross section of the second shaft section reducing to the cross section of the first shaft section in the direction of flow of the material and preferably forming the lower end of the burning zone 20. The annular channel 18 preferably extends circumferentially around the lower region of the first shaft section of the burning zone 20. For example, each of the shafts 2 of FIG. 1 have an annular channel 18, the latter being connected to the connecting channel 19.

The burning zone 20 is adjoined in the direction of flow of the material in each shaft 2 by a cooling zone 22 which extends as far as the material outlet 40. The cooling zone is formed in a shaft section with a cross section that is substantially constant or becomes smaller toward the bottom. The cross section of the shaft section of the cooling zone 22 is larger than the cross section of the lower region of the burning zone 20, with the result that a further material-free space 17, in particular an annular shoulder, in which no material is arranged, is formed at the upper end of the cooling zone 22 and adjacent to the burning zone 20. The material is cooled inside the cooling zone 22 to about 100° C. in countercurrent to the cooling gas flowing through the material. Arranged at the lower end of the cooling zone 22 is a preferably conical flow device which serves to conduct the material in the direction of the shaft wall.

Each cooling zone 22 has a respective cooling air outlet device 17 having a respective cooling gas outlet 29. In the exemplary embodiment of FIG. 1, the cooling air outlet device 17 is in the form of a material-free, in particular annular, space 17. The cooling gas outlet 29 is preferably arranged in the shaft wall of the material-free space 17 at the upper end of the cooling zone 22. The cooling gas flowing into the cooling zone 22 via the cooling gas inlet 23 preferably flows completely out of the cooling gas outlet 29 of the cooling air outlet device 17 out of the respective shaft 2.

A discharge device 41 is preferably arranged at the material-outlet-side end of each shaft 2. The discharge devices 41 comprise for example horizontal plates, preferably a discharge table, which allow the material to pass through laterally between the discharge table and the housing wall of the PFR shaft kiln. The discharge device 41 is preferably embodied as a push table or rotary table or as a table with push-type scraper means. This enables a uniform throughput speed of the material to be burned through the shafts 2. By way of example, the discharge device 41 also comprises the outlet funnel 25, which adjoins the discharge table and has the material outlet 40 attached at its lower end.

During operation of the PFR shaft kiln 1, in each case one of the shafts 2 is active, with the respective other shaft 2 being passive. The active shaft 2 is referred to as burning shaft and the passive shaft 2 is referred to as regenerative shaft. The PFR shaft kiln 1 is in particular operated in cycles, with a typical number of cycles being 75 to 150 cycles per day, for example. After the cycle time has expired, the function of the shafts 2 is swapped. This procedure is repeated continuously. Material such as limestone or dolomite rock is alternately fed into the shafts 2 via the material inlets 3. In the active shaft 2 operated as a burning shaft, a fuel is introduced into the burning shaft 2 via the burner lances 10. The material to be burned is heated in the preheating zone 21 of the burning shaft to a temperature of about 700° C. In the exemplary embodiment of FIG. 1, the left-hand shaft 2 is operated as a burning shaft, with the right-hand shaft 2 being operated as a regenerative shaft.

During operation of the PFR shaft kiln 1, both in the burning shaft 2 and in the regenerative shaft 2, the cooling gas flows through the cooling zone 22 in countercurrent to the material to be cooled and is preferably completely discharged from the shaft 2 via the cooling gas outlet 29 so that preferably no cooling gas flows from the cooling zone 22 into the burning zone 20.

Inside the shaft 2 operated as a burning shaft, the combustion gas flows through the combustion gas inlet 12 into the burning shaft and in co-current with the material inside the burning zone 20 into the material-free space in the form of an annular channel 18. From the material-free space 18, the gas flows via the connecting channel 19 into the shaft 2 operated as a regenerative shaft 2. Inside the regenerative shaft, the gas flows from the connecting channel 19 and the material-free space 18 of the regenerative shaft in countercurrent to the material to be burned through the burning zone 20 into the preheating zone 21 and leaves the regenerative shaft through the exhaust gas outlet 6 of the regenerative shaft. The exhaust gas discharged from the shaft 2 preferably has a temperature of 60° C. to 160° C., preferably 100° C.

The exhaust gas is conducted into an exhaust gas line 39 which adjoins the exhaust gas outlet 6. The exhaust gas line 39 optionally has, downstream of the exhaust gas outlet 6 in the direction of flow of the exhaust gas, an exhaust gas filter 31 for filtering fine particles, in particular dust, out of the exhaust gas. Downstream of the exhaust gas filter 31 the exhaust gas line 39 has a branching-off point, wherein part of the exhaust gas is conducted in a combustion gas line 4 to the combustion gas inlet 12. In the direction of flow of the exhaust gas, downstream of the branching-off point the combustion gas line 4 has by way of example a control element, such as a throttle flap, and a compressor 35. The combustion gas line 4 is preferably connected to the combustion gas inlets 12 of the shafts 2, with the exhaust gas being fed preferably only to the combustion gas inlet 12 of the shaft 2 operated as a burning shaft via a control element connected upstream of the combustion gas inlet 12. The combustion gas line 4 is preferably connected to an oxidizing agent line 14 so that an oxidizing agent, preferably pure oxygen, is introduced into the combustion gas line 4 and then into the shaft 2 via the combustion gas inlet 12 together with the exhaust gas. It is also conceivable to introduce an oxygen-rich gas having a proportion of oxygen of at least 70% to 95%, preferably 90%, into the combustion gas line 4 as oxidizing agent.

The part of the exhaust gas not returned to the combustion gas inlet 12 is fed in the exhaust gas line 39 to a gas inlet 15 in the connecting channel 19. Downstream of the branching-off point of the combustion gas line 4 in the direction of flow of the exhaust gas, the exhaust gas line 39 preferably has an adjustable-volume compressor 36, a heat exchanger 43 and optionally a heating device 8 for heating the exhaust gas. By way of example, the heat exchanger 43 is in the form of a recuperator, wherein the exhaust gas is heated in countercurrent to the extracted cooling gas and the cooling gas is simultaneously cooled. In particular, the heat exchanger 43 is connected to the cooling gas outlets 29 of both shafts 2 via a cooling gas extraction line 11, so that the exhaust gas in the heat exchanger 43 is heated preferably in countercurrent by means of the extracted cooling gas. Downstream of the heat exchanger, the cooling gas extraction line 11 optionally has a control element for adjusting the amount of cooling gas to be extracted and a filter 16 for dedusting the cooling gas. The exhaust gas is preferably heated to a temperature of about 900°° C. to 1100° C., in particular 1000° C., in the heat exchanger 43 and/or the heating device 8. It is also conceivable for the exhaust gas line 39 to have only a heat exchanger 43 or a heating device 8 for heating the exhaust gas. By way of example, the exhaust gas is heated to a temperature of about 600° C. in the heat exchanger 43 and then to a temperature of about 1000° C. in the heating device 8.

The heating device 8 is for example an electrically operated heating device. In particular, the heating device is operated by means of solar energy. It is also conceivable for the heating device 8 to comprise a heat exchanger, wherein the heating medium flowing in countercurrent is heated by solar energy. The heating device 8 is preferably in the form of a combustion reactor for the combustion of preferably renewable energy sources, such as wood, wherein the combustion is preferably performed in such a way that the combustion gas has a high proportion of CO2 of at least 90%.

Part of the exhaust gas is branched off upstream of the heat exchanger 43 and discharged via a cooling device 32 by means of a compressor 37. Preferably, the entire amount of CO2 from the calcination and the combustion, and the water from the combustion, are discharged from the PFR shaft kiln 1. The cooling device 32 is for example a heat exchanger which is preferably operated with a coolant, such as water, in countercurrent. By way of example, the exhaust gas line has a compressor 34, 36 in each case before and after the branching-off point of the exhaust gas to be discharged.

The connecting channel 19 has a gas inlet 15 for admitting recirculated exhaust gas into the connecting channel 19. The gas inlet 15 is connected to the exhaust gas outlet 6 of the shaft 2 via the exhaust gas line 39 so that dedusted and heated exhaust gas discharged from the shaft 2 is conducted into the connecting channel 19. The gas inlet 15 is arranged by way of example centrally in the upper wall of the gas channel 15. It is also conceivable to arrange the gas inlet 15 at a position deviating therefrom in the wall of the connecting channel 19 or in the annular channels 18. It is also conceivable to install a multiplicity of gas inlets 15 in the connecting channel 19 or in the annular channels 18, each being connected to the exhaust gas line 39.

FIG. 1 further shows by way of example two gas analysis devices 45, 46. The gas analysis devices 45, 46 are configured such that they each determine the oxygen and/or CO₂ content of the respective gas. One gas analysis device 45 is arranged by way of example in the exhaust gas line 39 downstream of the branching-off point of the combustion gas line 4 and is configured to determine the oxygen and/or CO₂ content of the exhaust gas. In particular, the gas analysis device 45 is connected to a control device (not shown) for transmitting the determined oxygen and/or CO₂ content of the exhaust gas.

The oxidizing agent line 14 preferably has a control element, such as a valve or a flap, which can be used to adjust the amount of oxidizing agent in the combustion gas line 4. The control element is preferably connected to the control device, with the control device being configured in particular such that it controls the amount of oxidizing agent in the combustion gas line 4 depending on the oxygen and/or CO₂ content of the exhaust gas that is determined by means of the gas analysis device 45.

The control serves in particular for complete combustion of the fuel that is fed to the PFR shaft kiln 1 via the fuel line 9. An undesirably high proportion of oxygen in the exhaust gas line 39 is thus prevented. The CO₂ content is also measured in order to control the desired CO₂ content in the exhaust gas line 39.

The control device is preferably configured such that it compares the oxygen and/or CO₂ content determined by means of the gas analysis device 45 with a respective predetermined limit value or limit range and, in the case of a deviation of the determined value from the limit value or limit range, increases or reduces the amount of oxidizing agent in the combustion gas line.

The amount of oxidizing agent is preferably increased if the limit value or limit range of the determined oxygen content is undershot. The amount of oxidizing agent is preferably reduced if the limit value or limit range of the determined oxygen content is exceeded.

One gas analysis device 46 is arranged by way of example in the cooling gas extraction line 11, in particular downstream of the heat exchanger 43 and for example of the filter 16, and is configured to determine the oxygen and/or CO₂ content of the discharged cooling gas. In particular, the gas analysis device 46 is connected to the control device (not shown) for transmitting the determined oxygen and/or CO₂ content of the cooling gas.

The cooling gas extraction line 11 preferably has a control element, such as a valve or a flap, which can be used to adjust the amount of cooling gas to be discharged via the cooling gas extraction device 17. The control element is preferably connected to the control device, with the control device being configured in particular such that it controls the amount of cooling gas discharged via the cooling gas extraction device 17 depending on the oxygen and/or CO₂ content of the cooling gas that is determined by means of the gas analysis device 46.

The control serves in particular to remove the cooling gas from the PFR shaft kiln 1 as completely as possible while at the same time having as little CO₂ as possible or preferably no CO₂ in the cooling gas extraction line 11.

The control device is preferably configured such that it compares the oxygen and/or CO₂ content determined by means of the gas analysis device 46 with a respective predetermined limit value or limit range and, in the case of a deviation of the determined value from the limit value or limit range, increases or reduces the amount of cooling gas to be discharged via the cooling gas extraction device 17.

The amount of cooling gas is preferably increased if the limit value or limit range of the determined CO₂ content is undershot. The amount of cooling gas is preferably reduced if the limit value or limit range of the determined CO₂ content is exceeded.

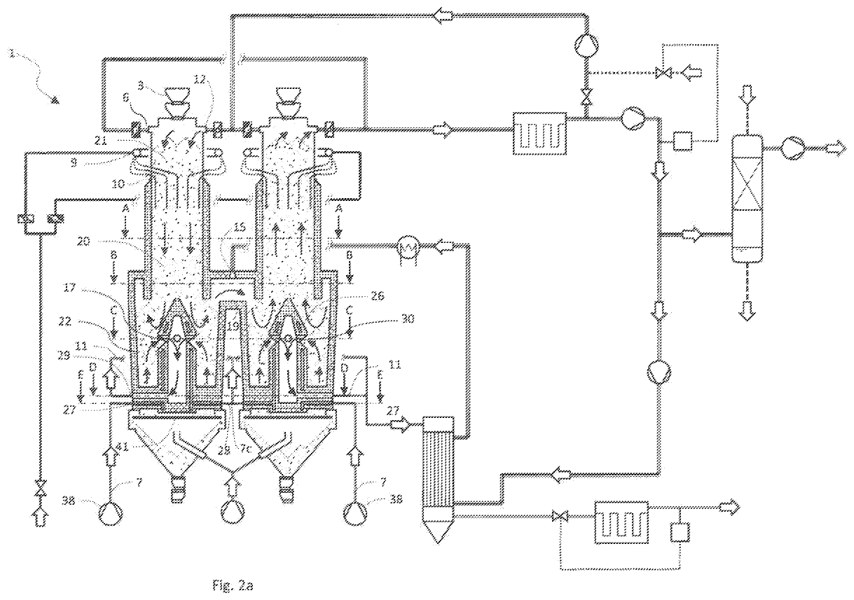

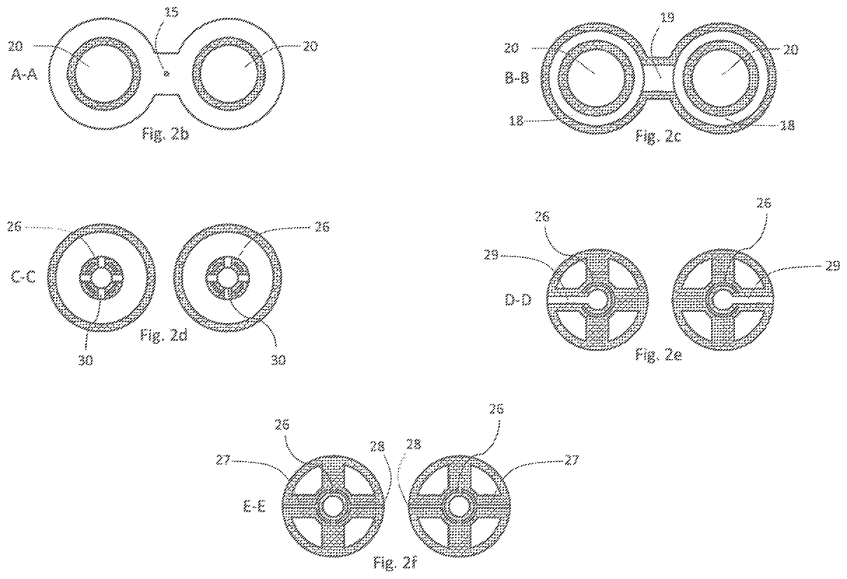

FIG. 2a shows a further exemplary embodiment of a PFR shaft kiln, said kiln largely corresponding to the PFR shaft kiln of FIG. 1. Identical elements are provided with identical reference signs. By way of example, in the PFR shaft kiln 1 of FIG. 2a the left-hand shaft 2 is operated as a burning shaft. In contrast to the PFR shaft kiln of FIG. 1, the PFR shaft kiln 1 of FIG. 2a has a cooling gas extraction device 17 comprising an inner cylinder 26 which extends from the cooling zone 22 at least partially into the burning zone 20 and has a cooling gas outlet 29 which is connected to the cooling gas extraction line 11. FIGS. 2b to 2f show cross-sectional views of the PFR shaft kiln 1 in the sectional planes marked in FIG. 2a.

The cooling zone 22 is formed by way of example in a shaft section which has an approximately constant cross section, the shaft cross section of the cooling zone 22 corresponding to the shaft cross section of the lower region of the burning zone 20. The material-free annular space of the PFR shaft kiln of FIG. 1 is therefore not formed in the exemplary embodiment of FIG. 2a. Each shaft 2 of the PFR shaft kiln 1 of FIG. 2a has an inner cylinder 29 which extends centrally in the vertical direction through the cooling zone 22. By way of example, the inner cylinder 29 extends from the discharge device 41 through the cooling zone 22 into the burning zone 20 up to the height of the connecting channel 19. To cool the inner cylinder 29, a multiplicity of cooling air channels are formed in its outer walls and are connected to a cooling air line 7 for conducting cooling air. The cooling air is preferably conducted by means of a compressor 38 via the cooling air line 7 into the cooling air channels of the inner cylinder 26. By way of example, the heated cooling air is conducted into the cooling gas extraction line 11 and preferably fed into the heat exchanger 43 in order to heat the exhaust gas. The inner cylinders 26 each have a radially outwardly extending cooling air inlet 27 and a cooling air outlet 28 which are connected to the cooling air line 7. FIG. 2f shows a cross-sectional view of the sectional plane E-E depicted in FIG. 2 through the cooling air inlets 27 and cooling air outlets 28 of the inner cylinder 26.

The inner cylinder 26 of the cooling gas extraction device 17 has a cooling gas outlet 29 which extends radially outward from the inner cylinder 26 through the shaft wall and serves to conduct cooling gas from the inner cylinder into the cooling gas extraction line 11. FIG. 2e shows a cross-sectional view of the sectional plane D-D depicted in FIG. 2a through the cooling gas outlet 29. The inner cylinder 26 also has a cooling gas inlet 30 for admitting cooling gas from the cooling zone 22 into the inner cylinder 26. The cooling gas inlet 30 extends through the inner cylinder wall into the cooling zone 22 and connects the interior of the inner cylinder 26 to the cooling zone 22. FIG. 2d shows a cross-sectional view of the sectional plane C-C depicted in FIG. 2a through the cooling gas inlet 30. By way of example, each inner cylinder 26 has four cooling gas inlets 30 which are each formed at the same height in the inner cylinder wall and preferably extend at a uniform distance from one another in a star shape outward into the cooling zone 22. The cooling gas inlet 30 is preferably arranged above the cooling gas outlet 29 in the cooling zone 22. During operation of the PFR shaft kiln 1, the cooling gas flows from the bottom to the top through the cooling zone 22 and into the cooling gas inlet 30 into the inner cylinder 26 of the cooling gas extraction device 17. Preferably, all of the cooling gas introduced into the cooling zone 22 flows through the cooling gas inlets 30 into the cooling gas extraction device 17 so that no cooling gas passes into the burning zone 20. The cooling air outlet 29 of the inner cylinder 26 is preferably arranged in the lower region of the cooling zone 22. In particular, the cooling gas flows downward from the cooling gas inlet 30 in the inner cylinder 26 to the cooling gas outlet 29.

The conduction of the cooling gas extracted from the cooling zone 22 and that of the exhaust gas extracted from the preheating zone 21 correspond in the exemplary embodiment of FIG. 2a to the interconnection described with reference to FIG. 1.

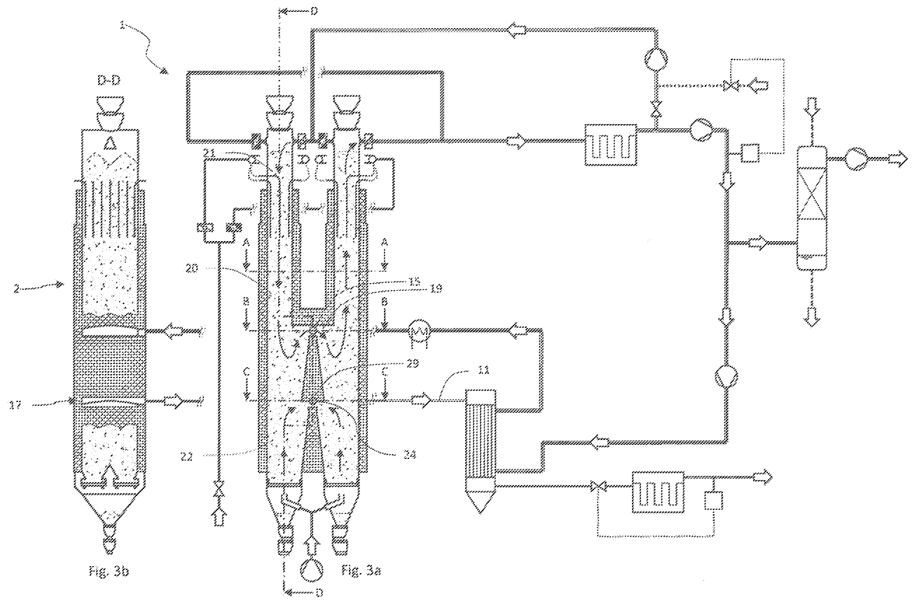

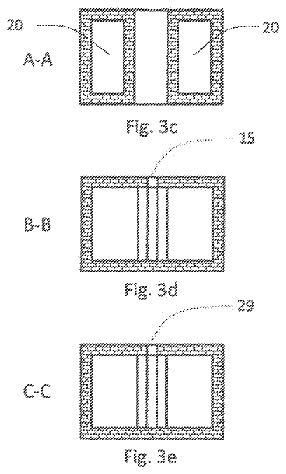

FIGS. 3a and b show a further exemplary embodiment of a PFR shaft kiln, said kiln largely corresponding to the PFR shaft kiln of FIGS. 1 and 2. Identical elements are provided with identical reference signs. By way of example, in the PFR shaft kiln 1 of FIG. 3 the left-hand shaft 2 is operated as a burning shaft. In contrast to the PFR shaft kiln of FIGS. 1 and 2, the PFR shaft kiln 1 of FIG. 3 has a cooling gas extraction device 17 comprising a further connecting channel 24 for connecting the cooling zones 22 of the two shafts 2 in terms of gas. The further connecting channel 24 is arranged below the connecting channel 19 for connecting the burning zones 20 of the two shafts 2 in terms of gas. The further connecting channel 24 is in particular arranged at the upper end of the cooling zone 22, preferably directly below the burning zone 20. The cooling gas outlet 29 is in the further connecting channel 24 for discharging the cooling gas, in particular completely, from the two shafts 2 into the cooling gas extraction line 11. By way of example, the cooling gas outlet 29 is arranged centrally inside the further connecting channel 24. FIG. 3b shows a longitudinal sectional illustration of the PFR shaft kiln of FIG. 3a at the sectional plane D-D shown in FIG. 3a. FIG. 3c to FIG. 3e show further cross-sectional views of the PFR shaft kiln 1 of FIG. 3a at the sectional planes indicated in FIG. 3a. By way of example, the shafts 2 of the exemplary embodiment of FIGS. 3a to e have a rectangular cross section. The cooling gas outlet 29 extends by way of example over the entire width of the cross section of the shaft 2 and out of the shaft wall.

The conduction of the cooling gas extracted from the cooling zone 22 and that of the exhaust gas extracted from the preheating zone 21 correspond in the exemplary embodiment of FIG. 3 to the interconnection described with reference to FIG. 1.

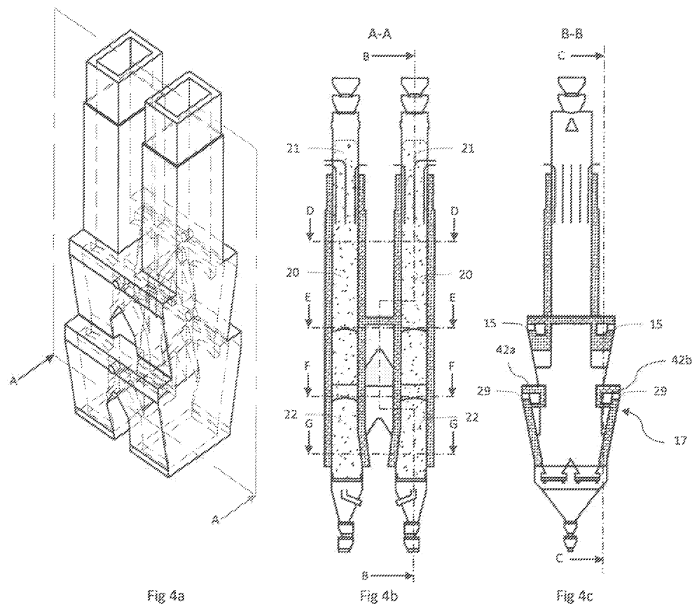

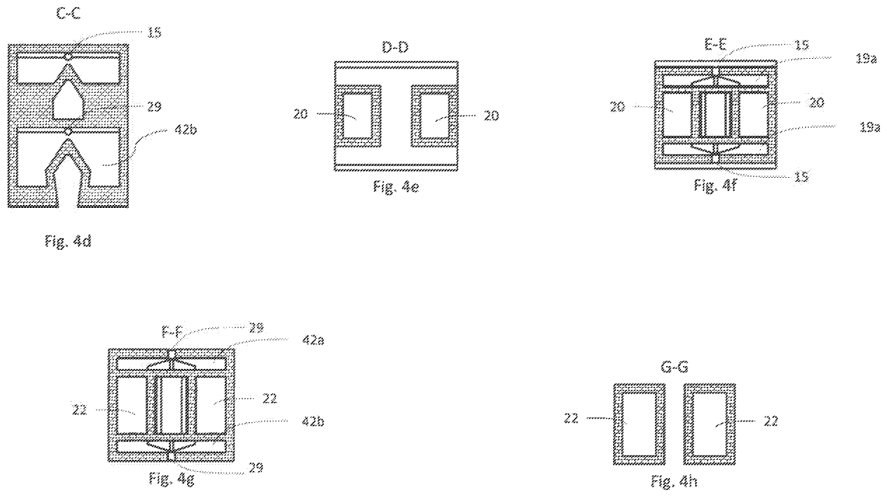

FIGS. 4a-h show a further exemplary embodiment of a PFR shaft kiln, said kiln largely corresponding to the PFR shaft kiln of FIG. 3. Identical elements are provided with identical reference signs. In contrast to the PFR shaft kiln of FIG. 3, the PFR shaft kiln 1 of FIGS. 4a-c has a cooling gas extraction device 17 comprising two connecting channels 42a,b. The connecting channels 42a,b are arranged parallel to one another and each extend on opposite outer sides of the shafts 2. The cooling zones 22 of the two shafts 2 are connected to one another in terms of gas via two connecting channels 42a,b. Each connecting channel 42a,b in particular has a respective cooling gas outlet 29 which is connected to a cooling gas extraction line 11 not shown in FIGS. 4a-c. FIG. 4d shows a sectional view of a connecting channel 42b at the sectional plane depicted in FIG. 4c. The cooling gas outlet 29 is formed by way of example centrally between the two shafts, preferably at the narrowest point of the connecting channel 42b. In particular, the connecting channels 42a,b are identical. The cross section, in particular the height, of the connecting channels 42 increases in the direction of the shafts, in particular downward into the respective shaft 2, and decreases between the two shafts 2. The width of the connecting channels 42a,b is constant, for example.

FIGS. 4e to h show cross-sectional views of the PFR shaft kiln 1 at the sectional planes depicted in FIG. 4c. By way of example, in the exemplary embodiment of FIGS. 4a to h, the burning zones 20 of the shafts 2 are likewise connected via two parallel connecting channels 19a, b arranged externally on opposite sides of the shafts 2. The connecting channels 19a,b and/or 42a,b for connecting the burning zones 20 and the cooling zones 22 may optionally be arranged circumferentially around the two shafts 2.

The conduction of the cooling gas extracted from the cooling zone 22 and that of the exhaust gas extracted from the preheating zone 21 correspond in the exemplary embodiment of FIG. 4 to the interconnection described with reference to FIG. 1.

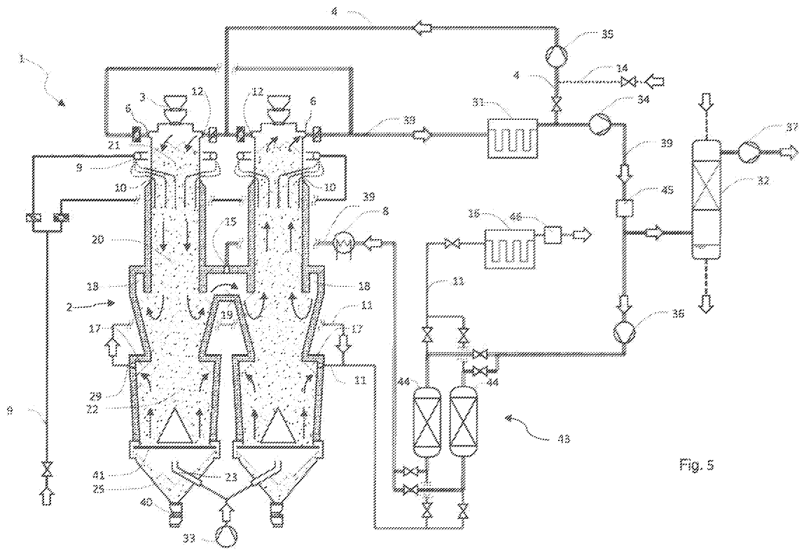

FIG. 5 shows a further exemplary embodiment of a PFR shaft kiln 1, said kiln largely corresponding to the PFR shaft kiln of FIG. 1. Identical elements are provided with identical reference signs. In contrast to the exemplary embodiment of FIG. 1, the PFR shaft kiln 1 of FIG. 5 is provided with a heat exchanger 43 in the form of a regenerator 44. By way of example, the heat exchanger 43 has two regenerators 44 which are connected in parallel to one another. The regenerators 44 are each connected to the exhaust gas line 39 and the cooling gas extraction line 11 via a respective valve, in particular a shut-off valve. During operation of the PFR shaft kiln, the extracted cooling gas flows in each case through exactly one of the regenerators 44 in order to heat the regenerator 44. The exhaust gas to be heated flows through the respective other regenerator 44. After a certain time, in particular when switching the shafts between the burning and regeneration operations, the operating modes of the regenerators are switched, so that the extracted cooling gas flows through the respective other regenerator with the exhaust gas to be heated. The regenerator 44 heated by means of the extracted cooling gas then gives off the heat to the exhaust gas.

The lime produced with the previously described PFR shaft kiln 1 of FIGS. 1 to 4 has a high reactivity, with process gas having a CO2 content of more than 90% based on dry gas being produced at the same time. With such a process exhaust gas, it is possible to liquefy and sequester it with less effort. For example, the liquefied process exhaust gas is fed to further process steps or stored. Alternatively, exhaust gas having a lower CO2 content, for example 45% for soda production or 35% for sugar production or 30% for the production of precipitated calcium carbonate, can be also generated with the previously described PFR shaft kiln.

### List of reference signs

1 PFR shaft kiln
2 Shaft
3 Material inlet/lock
4 Combustion gas line
6 Exhaust gas outlet
7 Cooling air line
8 Heating device
9 Fuel line
10 Burner lances
11 Cooling gas extraction line
12 Combustion gas inlet
14 Oxidizing agent line
15 Gas inlet
16 Filter
17 Material-free space/cooling gas extraction device
18 Annular channel/material-free space
19 Connecting channel
20 Burning zone
21 Preheating zone
22 Cooling zone
23 Cooling gas inlet
24 Further connecting channel of the cooling zones
25 Outlet funnel
26 Inner cylinder
27 Cooling air inlet
28 Cooling air outlet
29 Cooling gas outlet
30 Cooling gas inlet
31 Exhaust gas filter
32 Cooling device
33-38 Compressor
39 Exhaust gas line
40 Material outlet/lock
41 Discharge device
42a,b Connecting channels
43 Heat exchanger/recuperator
44 Regenerator
45, 46 Gas analysis device

1.-18. (canceled)

19. A method for burning material in a parallel-flow regenerative shaft kiln, comprising:
alternately operating a burning shaft and a regenerative shaft which are connected to one another by a connecting channel, wherein the material flows through a material inlet into a preheating zone for preheating the material, a burning zone for burning the material and a cooling zone for cooling the material to a material outlet;
forming a concurrent burning zone in the burning shaft;
admitting a cooling gas into the cooling zone;
discharging exhaust gas from one of the shafts via an exhaust gas outlet arranged inside or above the preheating zone; and
wherein discharging the exhaust gas from one of the shafts via the exhaust gas outlet is at least partially introduced into at least one of the shafts.

20. The method as claimed in claim 19, wherein the exhaust gas is introduced into the preheating zone of the burning shaft.

21. The method of claim 19, wherein the exhaust gas is introduced into the connecting channel and/or into the burning zone of the regenerative shaft.

22. The method of claim 21 wherein, before being introduced into the connecting channel or into the burning zone of the regenerative shaft, the exhaust gas is heated in particular to a temperature of 900° C. to 1100° C.

23. The method of claim 22 wherein, the exhaust gas is heated by a heat exchanger and/or a solar device or a combustion reactor.

24. The method of claim 22 wherein, the cooling gas heated in the cooling zone is discharged from the cooling zone of the shaft via a cooling gas extraction device.

25. The method of claim 23 wherein, the cooling gas discharged from the cooling zone is fed to a heat exchanger for heating the exhaust gas.

26. The method of claim 19 wherein, an oxidizing agent is fed to the shaft operated as a burning shaft.

27. The method of claim 25 wherein, the content of oxygen and/or CO2 in the exhaust gas and/or the cooling gas is determined and wherein the amount of oxidizing agent fed to the burning shaft and/or the amount of cooling gas discharged from the cooling zone of the shaft via the cooling gas extraction device is controlled.

28. The method of claim 19 wherein the shafts each have at least one burner lance and wherein the exhaust gas is introduced into the burner lance.

29. A parallel-flow regenerative shaft kiln for burning and cooling material, comprising:
two shafts which can be operated alternately as a burning shaft and as a regenerative shaft and are connected to one another by means of a connecting channel, wherein a concurrent burning zone is formed in the shaft operated as a burning shaft,
wherein each shaft includes, in a direction of flow of the material, a preheating zone for preheating the material, a burning zone for burning the material and a cooling zone for cooling the material, and
wherein each shaft includes an exhaust gas outlet arranged inside or above the preheating zone for discharging exhaust gas from the shaft, wherein at least one exhaust gas outlet is connected to a gas inlet for admitting gas into at least one shaft.

30. The parallel-flow regenerative shaft kiln of claim 29, wherein the gas inlet is arranged in the preheating zone of the shaft operated as a burning shaft.

31. The parallel-flow regenerative shaft kiln of claim 29, wherein the gas inlet is arranged in the connecting channel and/or the burning zone of the shaft and/or a material-free space in the shaft.

32. The parallel-flow regenerative shaft kiln of claim 29, wherein arranged between the exhaust gas outlet and the gas inlet in the connecting channel and/or burning zone is a heat exchanger and/or a heating device, in particular an electrical heating device, a solar device or a combustion reactor, for heating the exhaust gas.

33. The parallel-flow regenerative shaft kiln of claim 29, wherein the cooling zone includes a cooling gas inlet for admitting cooling gas into the cooling zone and a cooling gas extraction device for discharging cooling gas from the shaft.

34. The parallel-flow regenerative shaft kiln of claim 33, wherein the cooling gas extraction device is connected to a heat exchanger for heating the exhaust gas.

35. The parallel-flow regenerative shaft kiln of claim 33, wherein the cooling gas extraction device comprises a material-free space inside the cooling zone.

36. The parallel-flow regenerative shaft kiln of claim 29, wherein, wherein each shaft includes a combustion gas inlet for admitting combustion gas into the preheating zone and/or the burning zone and wherein the combustion gas inlet is connected to an oxidizing agent line for conducting an oxidizing agent into the shaft.
